(19) United States
(12) Patent Application Publication
(10) Pub. No.: US 2026/0273362 A1
(43) Pub. Date: Sep. 17, 2026

(54) ROUNDNET APPARATUS WITH RIM-IMPACT INDICATOR, ADJUSTABLE NET TENSION, AND FOLDABLE RIM ASSEMBLY

(71) Applicant: Shayne Gryba, Mississauga (CA)

(72) Inventor: Shayne Gryba, Mississauga (CA)

(21) Appl. No.: 19/561,362

(22) Filed: Mar. 9, 2026

Related U.S. Application Data
(60) Provisional application No. 63/770,194, filed on Mar. 11, 2025.

(51) Int. Cl. A63B 67/00; A63B 71/06; F16G 11/14

(52) U.S. Cl. CPC A63B 67/002; A63B 71/06; F16G 11/14; A63B 2210/50

(57) ABSTRACT

A roundnet apparatus includes a foldable rim assembly, a net coupled to the rim by an adjustable elastic coupling system, a rim-impact indicator assembly, and, in some embodiments, overload-releasable leg assemblies. The rim assembly may include rim segments joined by hinges having overlapping geometry that promotes coplanar alignment in a deployed configuration and pinch-reducing surfaces that reduce pinch points during folding and unfolding. The net may include apertures receiving an elastic cord selectively engageable with discrete engagement features of retention members to set installed net tension while permitting the net to remain coupled during folding. The net may comprise a coated woven mesh, such as PVC-coated woven polyester mesh. The rim-impact indicator assembly may generate an audible, visual, tactile, or recorded output in response to a ball striking the rim, distinguishable from contact with the net. In some embodiments, leg couplings retain during normal play and release under overload.

### CROSS-REFERENCE TO RELATED APPLICATIONS

This application claims the benefit of U.S. Provisional Patent Application No. 63/770,194, filed Mar. 11, 2025, entitled “System and method for an improved roundnet apparatus,” the entire contents of which are incorporated herein by reference.

### STATEMENT REGARDING FEDERALLY SPONSORED RESEARCH OR DEVELOPMENT

Not applicable.

### FIELD OF THE INVENTION

The present disclosure relates generally to sports equipment and, more particularly, to roundnet apparatuses and related systems and methods for improving portability, installed net-tension repeatability, durability, and boundary-call clarity during play.

### BACKGROUND OF THE INVENTION

Roundnet products generally include a frame and a rebound surface configured to return a ball during play. Conventional roundnet products typically have a generally flat, trampoline-like playing surface and are assembled from multiple frame components, including rim and leg components, that are disassembled between uses.

Conventional roundnet products present several drawbacks. In many products, the frame can be damaged if a user falls onto the apparatus during play. In addition, the netting of many conventional products must be unstrung during disassembly and restrung before each subsequent use, making setup laborious and causing substantial variation in installed net tension from one use to the next.

Conventional roundnet products also commonly use nylon or polyester netting that relies on the intrinsic elasticity of the net material to provide rebound. Further, conventional roundnet products do not clearly distinguish the boundary defined by the rim from the interior netting during play. This creates gameplay ambiguity because, under typical roundnet rules, a ball striking only the net remains in play while a ball striking the rim is out of bounds.

Accordingly, there remains a need for improved roundnet apparatuses that provide faster setup, more repeatable installed net tension, improved portability, reduced risk of damage under overload, and clearer boundary indication during play.

### BRIEF SUMMARY OF THE INVENTION

In one aspect, the disclosure provides a roundnet apparatus including a rim defining a generally circular boundary of a playing area, a net coupled to the rim, and a rim-impact indicator assembly coupled to the rim and configured to generate a user-detectable output in response to a ball striking the rim, wherein the output is distinguishable from contact of the ball with the net.

In another aspect, the disclosure provides a net-to-rim coupling system including a net having a perimeter portion, an elastic cord routed along at least a portion of the perimeter portion, and a plurality of retention members coupled to a rim. Each retention member may include a plurality of discrete engagement features, wherein the elastic cord is selectively engageable with the discrete engagement features to select among multiple effective elastic lengths and thereby set an installed tension of the net.

In another aspect, the disclosure provides a foldable roundnet rim assembly including a plurality of rim segments arranged to define a generally circular rim in a deployed configuration and a plurality of hinges coupling adjacent rim segments such that the rim assembly is movable between the deployed configuration and a folded configuration. In certain embodiments, the hinges include overlapping geometry that promotes coplanar alignment of adjacent rim segments in the deployed configuration, and contoured pinch-reducing surfaces that reduce pinch points during folding and unfolding.

In certain embodiments, the net may remain coupled to the rim assembly while the rim assembly moves between deployed and folded configurations. In certain embodiments, the net comprises a coated woven mesh, such as PVC-coated woven polyester mesh, and the elastic cord may be an elastic shock cord or elastic paracord. In certain embodiments, the apparatus further includes leg assemblies coupled to the rim by overload-releasable couplings, such as couplings using magnetic retention and mechanical interference features to provide stability during normal gameplay while permitting predictable release under overload.

In a further aspect, the disclosure provides a method of manufacturing a net for a roundnet apparatus, including providing a generally circular woven mesh panel, forming a plurality of apertures in a peripheral portion of the woven mesh panel, and routing an elastic cord through the apertures for coupling the net to a rim.

These and other aspects, embodiments, and advantages of the disclosure will be apparent from the following description, drawings, and claims.

### BRIEF DESCRIPTION OF THE DRAWINGS

FIG. 1 is a perspective view of a roundnet apparatus 100 in a deployed configuration, showing a rim assembly 110, a net 126 coupled to the rim assembly 110, a plurality of retention members 120, a plurality of indicator elements 142, and a plurality of leg assemblies 150.

FIG. 2 is a perspective view of the roundnet apparatus 100 in a folded configuration, showing the rim assembly 110 in the folded configuration.

FIG. 3 is a cross-sectional view of the roundnet apparatus 100 in the folded configuration, showing the internal cavity or stowed region 170.

FIG. 4 is an exploded perspective view of the rim assembly 110, showing a plurality of rim segments 112, hinges 114, hinge pins 116, and retention members 120 having discrete engagement features 122.

FIG. 5 is a detailed view of a hinge region in a deployed configuration, illustrating overlapping hinge geometry configured to align adjacent rim segments 112 in a common plane, together with a pinch-reducing surface region 118 and an optional rotation stop 119.

FIG. 6 is a further detailed view of the hinge region of FIG. 5 in the deployed configuration.

FIG. 7 is a detailed view of a hinge region during folding or unfolding, illustrating pinch-reducing surface regions 118 configured to reduce pinch points as adjacent rim segments 112 rotate about a hinge pin 116.

FIG. 8 is a further detailed view of the hinge region of FIG. 7 during folding or unfolding.

FIG. 9 is a view of a first hinge configuration illustrating a gap width 113 between adjacent rim segments 112 and an axial stack length 117 of a hinge knuckle stack.

FIG. 10 is a view of a second hinge configuration, different from the hinge configuration of FIG. 9, illustrating a gap width 113 between adjacent rim segments 112.

FIG. 11 is a detailed view of a retention member 120 illustrating a plurality of discrete engagement features 122.

FIG. 12 is a partially assembled plan view of the net 126, illustrating the routing of the elastic cord 124 through a generally circular woven mesh panel having a peripheral portion with a plurality of apertures 128 and an optional peripheral reinforcement band 130.

FIG. 13 is a partial assembled view illustrating coupling of the net 126 to the rim assembly 110, showing the elastic cord 124 selectively engaged with the discrete engagement features 122 of the retention members 120 to set an installed tension of the net 126.

FIG. 14 is a detailed view showing the elastic cord 124 routed through apertures 128 of the net 126.

FIG. 15 is a cross-sectional view of a rim-impact indicator assembly 140 coupled to the rim assembly 110, showing an indicator element 142 coupled to a rim segment 112 with an attachment feature 148, with indicator element 142 including a resilient member 144 in a rest position.

FIG. 16 is an exploded view of an indicator element 142 and a rim segment 112, illustrating attachment of the indicator element 142 to the rim segment 112 by one or more attachment features 148.

FIG. 17 is a cross-sectional view illustrating actuation of the rim-impact indicator assembly 140 in response to impact of a ball 180 on the rim assembly 110, showing deflection of the resilient member 144 and generation of a user-detectable output 190.

FIG. 18A is a perspective view of a leg assembly 150 in an extended configuration, showing first and second leg sections 152a, 152b coupled by a hinged joint 153 to define a generally V-shaped support.

FIG. 18B is a perspective view of the leg assembly 150 in a folded configuration for compact storage.

FIG. 19 is an exploded perspective view illustrating coupling of the leg assembly 150 to the rim assembly 110, including a magnet 156, a ferromagnetic plate 158, a plate support 160, and one or more mechanical interference features 162.

FIG. 20 is a cross-sectional view illustrating coupling of the leg assembly 150 to the rim assembly 110.

### DETAILED DESCRIPTION OF THE INVENTION

Referring to the drawings, embodiments described herein relate to a roundnet apparatus 100 configured to improve portability, repeatability of installed net tension, and boundary-call clarity during play. In various embodiments, the apparatus 100 includes a rim assembly 110 defining a generally circular boundary of a playing area; a net 126 coupled to the rim assembly 110; and a rim-impact indicator assembly 140 coupled to the rim assembly 110 and configured to generate a user-detectable output 190 in response to a ball 180 striking the rim assembly 110, wherein the user-detectable output 190 is distinguishable from contact of the ball 180 with the net 126.

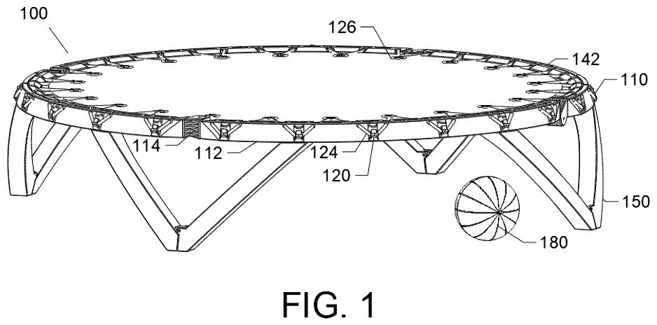

In certain embodiments, the rim assembly 110 is foldable between a deployed configuration and a folded configuration (FIGS. 1-3) to reduce storage volume. The rim assembly 110 may be supported above a playing surface by a plurality of leg assemblies 150 (FIG. 1).

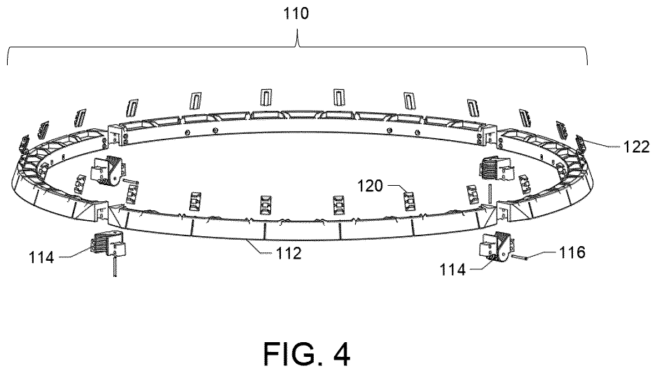

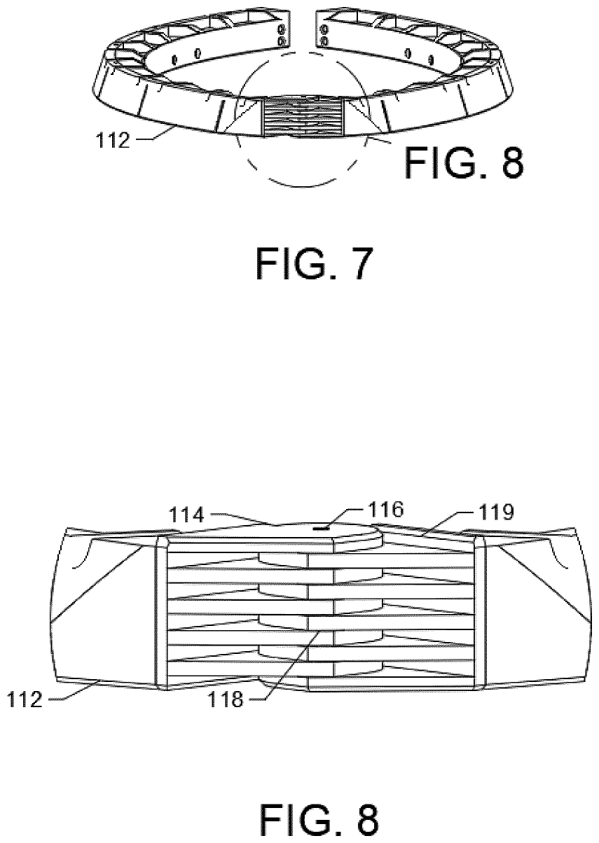

With reference to FIGS. 1-8, the rim assembly 110 may include a plurality of rim segments 112 arranged to define a generally circular rim in the deployed configuration. Adjacent rim segments 112 may be coupled by hinges 114 with hinge pins or axles 116 such that the rim assembly 110 is movable between the deployed configuration and the folded configuration.

In the deployed configuration (FIGS. 1 and 5-6), each hinge 114 may include hinge knuckles and/or mating hinge geometry having overlapping geometry configured to align adjacent rim segments 112 in a common plane. In particular, the overlapping geometry may define one or more bearing interfaces that, when the rim assembly 110 is in the deployed configuration, constrain relative angular misalignment between adjacent rim segments 112 about at least one axis transverse to a hinge axis 115, thereby reducing out-of-plane tilt between the adjacent rim segments 112 and promoting coplanar alignment.

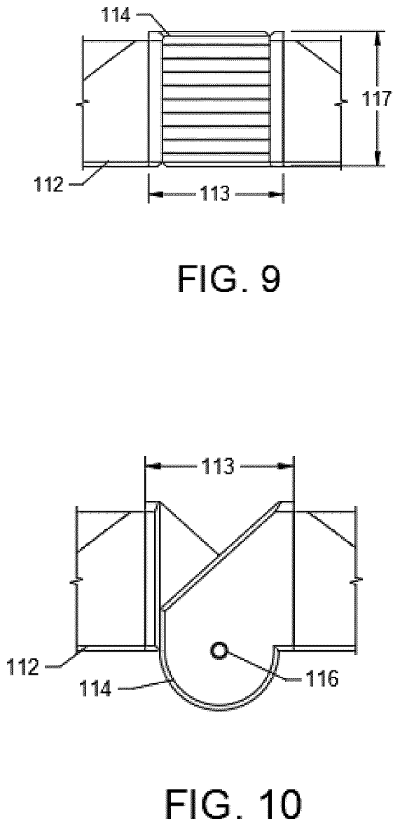

In certain embodiments (FIGS. 9-10), the hinge knuckles define a knuckle stack having an axial stack length 117 measured parallel to the hinge axis 115. Adjacent rim segments 112 further define a gap 113 having a width measured between opposing end faces of the adjacent rim segments 112 along a circumferential direction of the rim. In certain embodiments, the gap width 113 is greater than or equal to 50% of the axial stack length 117. This relationship may increase the effective overlap engagement along the hinge region and improve repeatability of rim-segment alignment in the deployed configuration.

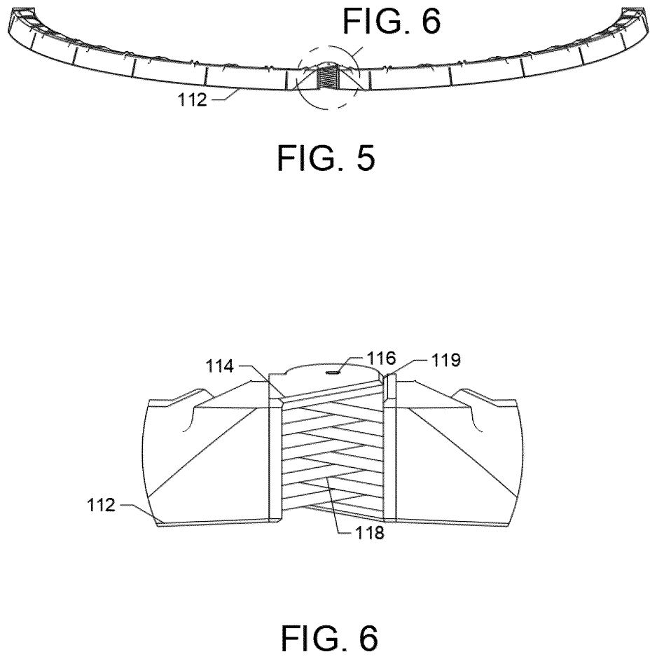

In certain embodiments, each hinge 114 further includes contoured pinch-reducing surface region(s) 118 configured to reduce pinch points during folding and unfolding (FIGS. 5-8). The pinch-reducing surface region(s) 118 may reduce pinch points by spacing, rounding, and/or otherwise controlling gaps and relative angles between moving hinge surfaces as the rim segments 112 rotate about the hinge pin 116.

In certain embodiments, a rotation stop 119 is provided to define the deployed configuration and limit over-rotation (FIGS. 5-8).

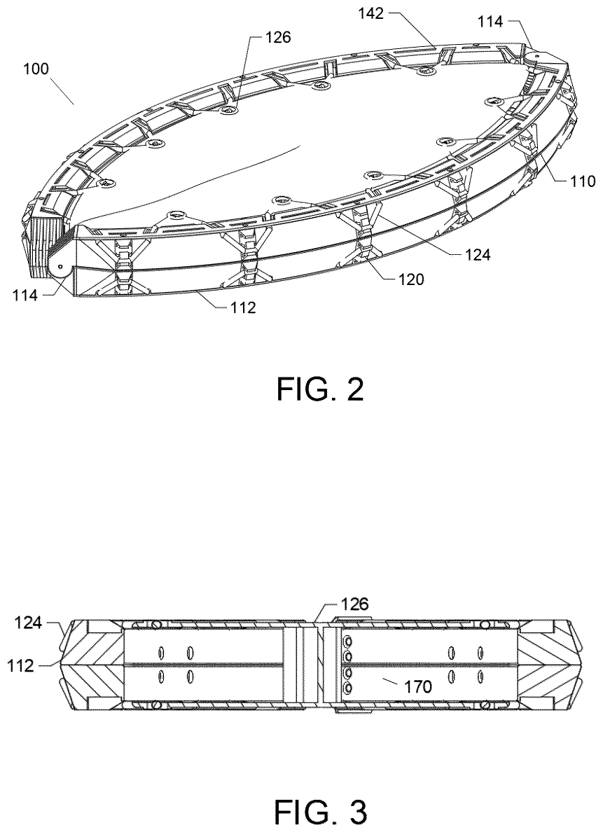

In some embodiments, the folded configuration defines an internal cavity or stowed region 170 configured to store detached components, such as legs, and/or accessories during transport (FIGS. 2-3).

With reference to FIGS. 1 and 11-14, the net 126 may include a generally circular woven mesh panel having a peripheral portion. The peripheral portion includes a plurality of apertures 128 configured to receive an elastic cord 124 for coupling the net 126 to the rim assembly 110. The apertures 128 may be reinforced openings, eyelets, grommets, sewn loops, or other connection points suitable for receiving the elastic cord 124.

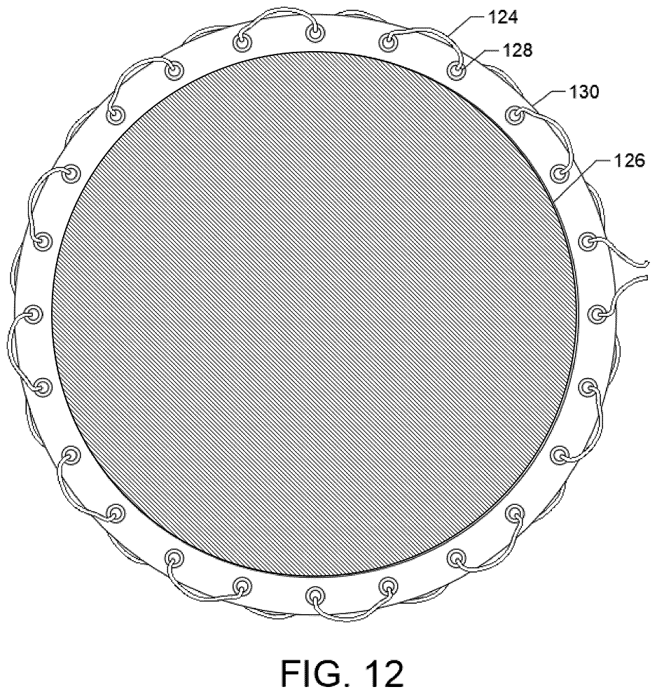

In certain embodiments, the net 126 further includes a peripheral reinforcement band 130 secured to the peripheral portion of the woven mesh panel, and the apertures 128 extend through the reinforcement band 130 (FIG. 12).

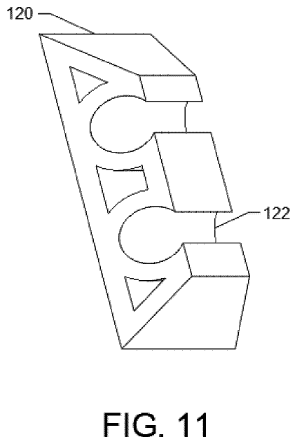

In certain embodiments, the elastic cord 124 is routed in an alternating pattern between the plurality of apertures 128 of the net 126 and a plurality of retention members 120 coupled to the rim assembly 110 (FIGS. 11-14), such that the elastic cord 124 passes through an aperture 128, engages a retention member 120, passes through a subsequent aperture 128, engages a subsequent retention member 120, and continues in alternating succession around at least a portion of the perimeter of the net 126. Each retention member 120 includes a plurality of discrete engagement features 122, and the elastic cord 124 is selectively engageable with the discrete engagement features 122 to select among multiple effective elastic lengths and thereby set an installed tension of the net 126.

In one embodiment, the retention members 120 comprise hooks circumferentially distributed around the rim assembly 110 such that net tension is substantially uniformly applied around the rim assembly 110 (FIG. 1).

The discrete engagement features 122 may comprise stepped notches defining distinct seating positions, a multi-rung ladder geometry defining multiple rungs, and/or other spaced posts, slots, recesses, teeth, or protrusions configured to provide multiple discrete retention positions for the elastic cord 124 (FIG. 11).

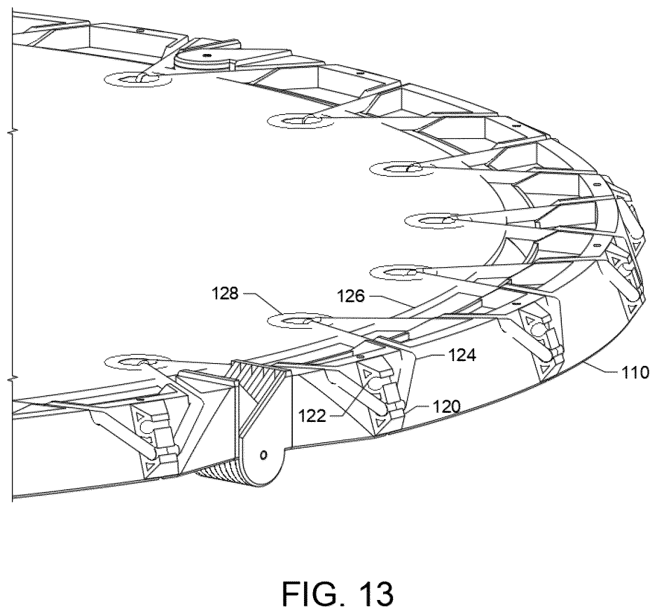

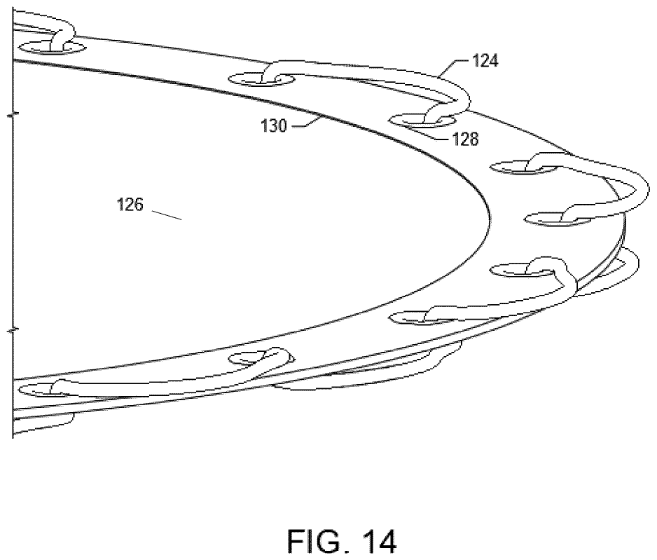

In certain embodiments, the discrete engagement features 122 are positioned to provide a plurality of engagement locations at different effective radii and/or different effective path lengths relative to the rim assembly 110, such that selecting different engagement locations changes the effective elastic length and the installed net tension (FIG. 13).

In certain embodiments, the elastic cord 124 comprises an elastic shock cord or elastic paracord.

In certain embodiments, the net 126 and elastic cord 124 are configured to remain coupled to the rim assembly 110 while the rim assembly 110 is moved between the deployed configuration and the folded configuration. In such embodiments, the elasticity of the cord 124 and/or deformability of the net 126 permits the net plane to deform during folding and unfolding without requiring users to detach and reattach the net 126 between uses.

In certain embodiments, the woven mesh panel of the net 126 comprises a coated woven mesh. In a primary embodiment, the net 126 comprises a PVC-coated woven polyester mesh.

In other embodiments, the coated woven mesh comprises polyester fibers and/or fiberglass fibers and a polymer coating selected from PVC, TPU, or polyurethane.

In certain embodiments, the woven mesh has an open-area percentage and an areal density selected to reduce energy loss of ball rebound at an operating net-tension range.

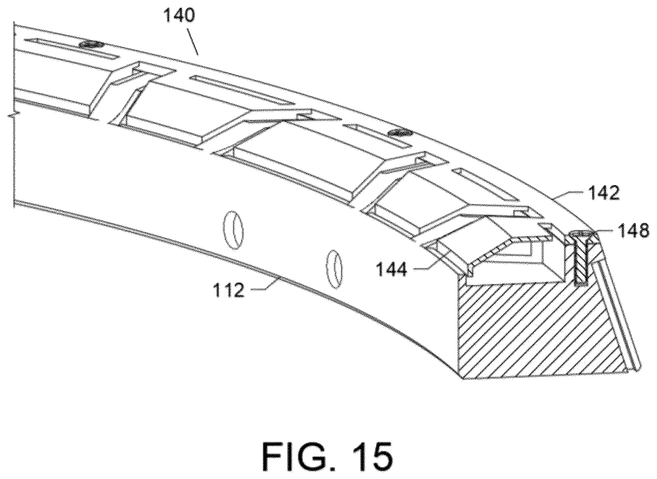

With reference to FIGS. 1 and 15-17, a rim-impact indicator assembly 140 is coupled to the rim assembly 110 and configured to generate a user-detectable output 190 in response to a ball 180 striking the rim assembly 110, wherein the output 190 is distinguishable from contact of the ball 180 with the net 126.

In certain embodiments, the rim-impact indicator assembly 140 comprises one or more indicator elements 142 attached to respective rim segments 112.

In certain embodiments, an indicator element 142 includes a resilient member 144 movable between a rest position and a deflected position in response to the ball 180 striking the rim assembly 110, and during deflection the resilient member 144 contacts a strike surface to produce an audible output, such as a “clack,” wherein the strike surface may be provided by a surface region of the rim assembly 110 and/or a surface region of the indicator element 142 itself (FIG. 17).

In one embodiment, the resilient member 144 comprises a cantilevered polymer member biased toward the rest position by material elasticity.

In certain other embodiments, the indicator elements 142 may be discrete and circumferentially spaced around the rim assembly 110, and/or may be implemented as an annular indicator element extending along at least a portion of the rim circumference.

Although certain embodiments emphasize an audible output, in other embodiments the user-detectable output 190 may additionally or alternatively comprise a visual output, a tactile output, a mechanically recorded output, an electronically recorded output, or any combination thereof.

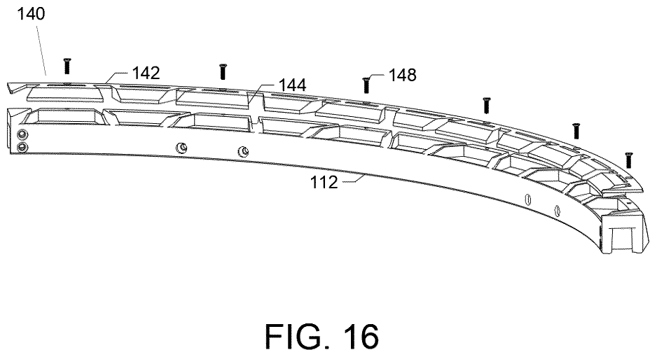

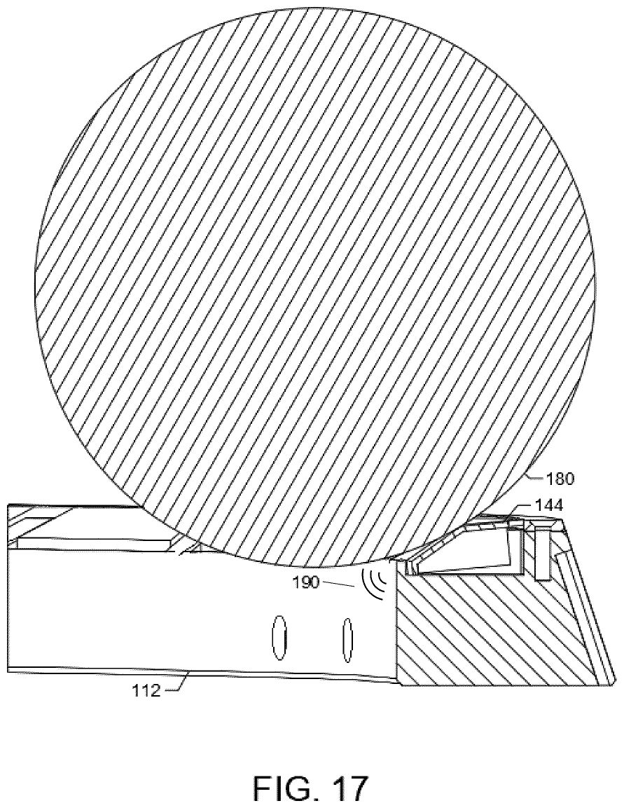

The rim-impact indicator elements 142 may be coupled to the rim assembly 110 by one or more mechanical fasteners, a snap-fit, an interference fit, an adhesive bond, welding, overmolding, or integral formation with the rim assembly 110, with FIG. 16 illustrating one example using attachment feature(s) or fastener(s) 148.

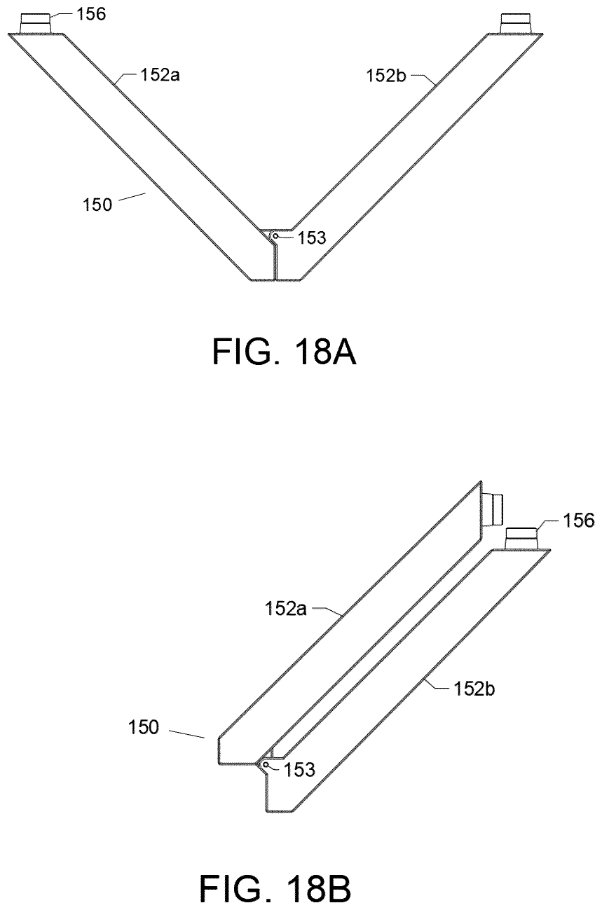

With reference to FIGS. 1, 18A, 18B, and 19-20, the apparatus 100 may include a plurality of leg assemblies 150 coupled to the rim assembly 110 to support the rim assembly 110 above a playing surface. In one embodiment, each leg assembly 150 includes first and second leg sections 152a and 152b coupled via a hinged joint 153 such that, in an extended position, the leg sections 152a, 152b define a generally V-shaped support (FIG. 18A), and such that the leg sections 152a, 152b are foldable into a folded configuration for compact storage (FIG. 18B).

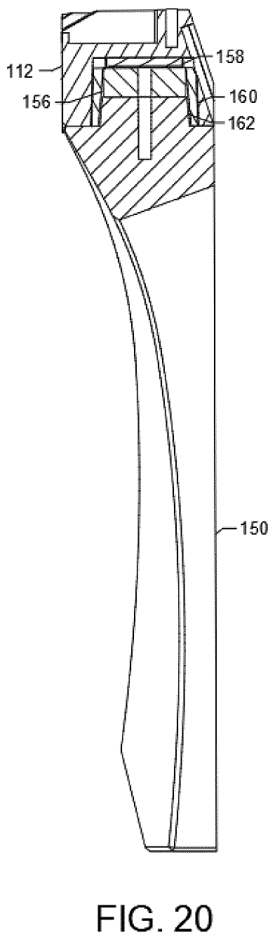

In certain embodiments, the legs are coupled to the rim assembly 110 by a coupling configured to (i) retain the legs during normal gameplay loads and (ii) release under an overload to reduce damage or injury (FIG. 20).

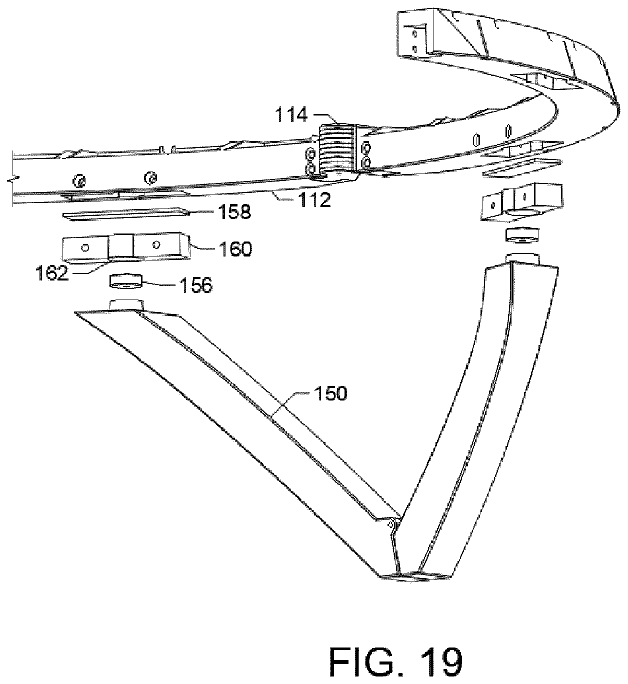

In one embodiment, the coupling comprises magnetic retention and a mechanical interference feature configured to provide stability while permitting release under the overload (FIGS. 19-20). For example, a magnet 156 may be disposed in or on the leg assembly 150 and configured to magnetically engage a ferromagnetic plate 158 positioned in or on a rim segment 112, optionally retained and/or positioned by a ferromagnetic plate support 160. Mechanical interference features 162 may be provided between the leg assembly 150 and rim segment 112 to increase stiffness and reduce wobble during play while still allowing predictable disengagement under sufficient overload.

In certain embodiments, the folded configuration of the rim assembly 110 defines the internal cavity or stowed region 170 sized and shaped to store detached leg assemblies 150 and/or accessories during transport (FIGS. 2-3).

In operation, a user may unfold the rim assembly 110 from a folded configuration to a deployed configuration while the net 126 and elastic cord 124 remain coupled to the rim assembly 110. The user may then couple the leg assemblies 150 to the rim assembly 110. If desired, the user may adjust installed net tension by selectively engaging the elastic cord 124 with discrete engagement features 122 of the retention members 120 to select an effective elastic length and corresponding tension (FIG. 13). During play, when the ball 180 contacts the rim assembly 110, the rim-impact indicator assembly 140 generates the user-detectable output 190 to assist players in distinguishing rim strikes from net contact (FIG. 17). Under overload conditions, the leg coupling may release to reduce damage and improve safety (FIG. 20).

A method of manufacturing a net 126 for a roundnet apparatus comprises providing a generally circular woven mesh panel; forming a plurality of apertures 128 in a peripheral portion of the circular woven mesh panel; and routing an elastic cord 124 through the plurality of apertures 128, wherein the elastic cord 124 is configured to be coupled to a rim assembly 110 to tension the net 126.

In certain embodiments, providing the generally circular woven mesh panel comprises providing a coated woven mesh comprising at least one of polyester fibers or fiberglass fibers and at least one polymer coating selected from PVC, TPU, or polyurethane. In certain embodiments, the method further includes securing a peripheral reinforcement band 130 to the peripheral portion, and forming the apertures 128 through the reinforcement band 130. In certain embodiments, forming the apertures 128 comprises installing a plurality of eyelets.

The number of rim segments 112, hinges 114, retention members 120, indicator elements 142, resilient members 144, and leg assemblies 150 may vary. The retention members 120 may take forms other than hooks, provided they include multiple discrete engagement features 122 enabling selection among multiple effective elastic lengths. The rim-impact indicator assembly 140 may be implemented as discrete elements 142 and/or as an annular element extending along at least a portion of the rim circumference, and the user-detectable output 190 may be audible, visual, tactile, recorded, or any combination thereof.

While certain embodiments have been described for purposes of illustration, the disclosed subject matter is not limited to the specifically described embodiments. Variations, combinations, substitutions, and modifications may be made without departing from the scope of the disclosure as defined by the claims.

1. A roundnet apparatus comprising:
a rim defining a generally circular boundary of a playing area;
a net coupled to the rim; and
a rim-impact indicator assembly coupled to the rim and configured to generate a user-detectable output in response to a ball striking the rim that is distinguishable from contact of the ball with the net.

2. The roundnet apparatus of claim 1, wherein the user-detectable output comprises an audible output.

3. The roundnet apparatus of claim 1, wherein the user-detectable output comprises a visual output, a tactile output, a mechanically or electronically recorded output, or any combination thereof.

4. The roundnet apparatus of claim 1, wherein the rim-impact indicator assembly comprises a plurality of discrete indicator elements circumferentially spaced around the rim.

5. The roundnet apparatus of claim 1, wherein the rim-impact indicator assembly comprises a resilient member movable between a rest position and a deflected position in response to the ball striking the rim.

6. The roundnet apparatus of claim 5, wherein the resilient member comprises a cantilevered polymer member biased toward the rest position by material elasticity.

7. The roundnet apparatus of claim 5, wherein the rim-impact indicator assembly comprises a strike surface, and the resilient member is configured to contact the strike surface to produce an audible output.

8. A net-to-rim coupling system for a roundnet apparatus, comprising:
a net having a perimeter portion;
an elastic cord routed along at least a portion of the perimeter portion; and
a plurality of retention members coupled to a rim, each retention member having a plurality of discrete engagement features, wherein the elastic cord is selectively engageable with the discrete engagement features to select among multiple effective elastic lengths and thereby set an installed tension of the net.

9. The coupling system of claim 8, wherein the retention members comprise hooks.

10. The coupling system of claim 8, wherein the discrete engagement features comprise stepped notches defining a plurality of distinct seating positions for the elastic cord.

11. The coupling system of claim 8, wherein the discrete engagement features comprise a plurality of spaced posts, slots, recesses, teeth, or protrusions configured to provide a plurality of discrete retention positions for the elastic cord.

12. The coupling system of claim 8, wherein the elastic cord is routed in an alternating pattern between a plurality of apertures along the net perimeter and the plurality of retention members.

13. The coupling system of claim 8, wherein the plurality of retention members are circumferentially distributed such that net tension is substantially uniformly applied around the rim.

14. The coupling system of claim 8, wherein the net and elastic cord are configured to remain coupled to the rim while the rim is moved between a deployed configuration and a folded configuration.

15. A foldable roundnet rim assembly comprising:
a plurality of rim segments arranged to define a generally circular rim in a deployed configuration; and
a plurality of hinges coupling adjacent rim segments such that the rim assembly is movable between the deployed configuration and a folded configuration,
wherein each hinge comprises hinge knuckles having overlapping geometry that, in the deployed configuration, constrains relative angular misalignment between adjacent rim segments about at least one axis transverse to a hinge axis so as to align the rim segments in a common plane.

16. The foldable roundnet rim assembly of claim 15, wherein, for at least one of the hinges, (i) the hinge knuckles define a knuckle stack having an axial stack length measured parallel to the hinge axis, and (ii) adjacent rim segments define a gap having a width measured between opposing end faces of the adjacent rim segments along a circumferential direction of the rim, and wherein the gap width is greater than or equal to 50% of the axial stack length.

17. The foldable roundnet rim assembly of claim 15, wherein each hinge further comprises contoured pinch-reducing surfaces configured to reduce pinch points during folding and unfolding.

18. The foldable roundnet rim assembly of claim 15, wherein the folded configuration defines an internal cavity configured to store detached components.

19. The roundnet apparatus of claim 1, wherein the net comprises:
a generally circular woven mesh panel having a peripheral portion; and
a plurality of apertures disposed in the peripheral portion, the plurality of apertures configured to receive an elastic cord for coupling the net to the rim.

20. The roundnet apparatus of claim 19, wherein the circular woven mesh panel comprises a coated woven mesh comprising at least one of polyester fibers or fiberglass fibers and at least one polymer coating selected from PVC, TPU, or polyurethane.

21. The roundnet apparatus of claim 1, further comprising a plurality of legs coupled to the rim by a coupling configured to (i) retain the legs during normal gameplay loads and (ii) release under an overload to reduce damage or injury.

22. The roundnet apparatus of claim 21, wherein the coupling comprises magnetic retention and a mechanical interference feature configured to provide stability while permitting release under the overload.
